(19) United States
(12) Patent Application Publication
(10) Pub. No.: US 2006/0196161 A1
(43) Pub. Date: Sep. 7, 2006

(54) Self-Propelled Agricultural Harvester

(75) Inventors: Bernard Krone, Spelle (DE); Josef Horstmann, Ibbenburen (DE); Bernward Overmeyer, Mettingen (DE); Markus Ester, Lunne (DE)

Correspondence Address: GUDRUN E. HUCKETT DRAUDT, LONSSTR. 53, WUPPERTAL, 42289, DE

(73) Assignee: MASCHINENFABRIK BERNARD KRONE GMBH, Spelle (DE)

(21) Appl. No.: 11/307,172

(22) Filed: Jan. 26, 2006

(30) Foreign Application Priority Data
Jan. 27, 2005 (DE) 102005006216.4

(51) Int. Cl. A01B 73/00

(52) U.S. Cl. 56/228

(57) ABSTRACT

A harvester has a harvesting device arranged in a traveling and working direction of the harvester in front of a driver's cab. The harvesting device has first, second, and third parts and extends with its length in a direction transverse to the traveling and working direction. At least the first and second parts are swivel parts that are pivotable about approximately 180 degrees about a pivot axis, respectively. The pivot axis extends approximately in the traveling and working direction, such that the swivel parts are transferable from a working position in which the swivel parts extend transversely to the traveling and working direction into a transport position. In the transport position legally permissible dimensions for traveling on roads are observed. A longitudinal extension of the swivel parts transverse to the traveling and working direction matches at least approximately a maximum legally permissible transport width.

### BACKGROUND OF THE INVENTION

The invention relates to a self-propelled agricultural harvester comprising a harvesting device in the form of a mowing and conveying device, a pick-up device or the like that is arranged preferably in the front area in the traveling and/or working direction in front of a driver's cab and is comprised of at least three parts. The harvesting device extends in its longest extension transversely to the traveling and working direction of the harvester. The harvesting device is designed such that by an approximately 180 degree pivot movement of at least two parts of the harvesting device about pivot axes that extend at least approximately in the traveling and working direction these parts can be transferred from an operating position, in which they extend transversely to the traveling and working direction, into a transport position so that the legally permissible dimensions, particularly the transport width, for a harvester traveling on roads are observed. In particular by its design and flexibility, the harvesting device significantly increases the efficiency of the harvester.

Harvesters of the aforementioned kind are available in numerous embodiments; preferably, they are harvesters with a harvesting attachment or implement for harvesting a stalky crop such as corn or the like.

Efficiency and speed are requirements that are to be improved upon continuously. Wider and wider working widths of the attachments or implements that are made possible by greater and greater motor output of the harvesters and that increase the efficiency of the harvester accordingly require however increasingly complex solutions with regard to handling and transport.

In order to prevent for road transportation of harvesters with harvesting devices of great working width a particularly time-consuming demounting of the harvesting device and transportation of the detached harvesting device on a separate transportation vehicle, different configurations of harvesting devices that provide a width reduction in a transport position are already known. In order to observe the legal regulations for driving a harvester on roads, not only a maximum width of, for example, 3 meters, must be observed but also a permissible maximum transport height and a permissible maximum limitation of the field of view of the driver, as well as a maximum axle load.

For example, U.S. Pat. No. 6,837,034 and U.S. Pat. No. 6,925,790 disclose a harvester with a harvesting device that is centrally divided wherein both halves can be pivoted from a working position parallel to the ground into a vertical transport position. Because of an especially advantageous position of the pivot axes and design of the suspension of the harvesting device halves, a harvesting device is embodied with simple means; the harvesting device, while fulfilling the aforementioned legal requirements, provides a great working width at minimal weight and minimal constructive expenditure.

The demand for even greater working widths is however limited in this configuration by the legally permissible transport height; moreover, the obstruction of the field of view caused by the halves of the harvesting device that are vertically oriented in the transport position is reduced to a minium by the intelligent arrangement of the pivot axes but is not completely avoidable.

Further known solutions in which the harvesting devices of the harvester are of a multi-part configuration and can be pivoted and/or swivelled about more than two axes enable possibly a greater working width, but all cause an obstruction of the field of view of the driver of the harvester. A particular disadvantage of such devices is however also their high constructive expenditure and the great weight connected therewith, the difficult handling, the negative effect on the center of gravity of the harvester, and, last but not least, the high manufacturing costs.

### SUMMARY OF THE INVENTION

It is an object of the present invention to improve a harvester of the aforementioned kind such that, when driving the harvester with attached harvesting device on roads, wherein the harvesting device having a working width that matches at least approximately 3 times the transport width and being especially of a lightweight and simple construction, the field of view of the driver is not obstructed by the harvesting device and all legal requirements, in particular in regard to the transport dimensions, are observed.

In accordance with the present invention, this is achieved in that the longitudinal extension of the at least two swivel parts of the harvesting device transversely to the traveling direction matches at least approximately the permissible maximum transport width, respectively.

In harvesters of the prior art, having a harvesting device that is at least subdivided into three parts wherein lateral parts are pivotably supported outwardly on a central part that has approximately transport width, the lateral parts after having been pivoted by about 180 degrees are positioned adjacent to one another on the central part. This means that the lateral parts can have maximally a width that matches half that of the central part.

In the advantageous configuration according to the invention, the lateral parts however can have a width that matches approximately the width of the central part and thus the transport width. This means that the total working width matches approximately a value of three times the transport width.

The wide configuration of the lateral parts of the harvesting device of the harvester is made possible according to the invention in that, by means of an intelligent height-displaced arrangement of the pivot axes of the lateral parts and by maintaining a sequential course when pivoting the lateral parts, the lateral parts are positioned after pivoting above one another and at least approximately parallel to one another on the central part with their bottom side facing upwardly, respectively.

Accordingly, in the transport position of a harvesting device a triple-layer package of harvesting device parts results which, in a direction transverse to the travel direction of the harvester, has maximally the permissible transport width.

In order to keep the height of the package as compact as possible, the pivot axes of the lateral parts according to the invention are not precisely parallel to an imaginary vertical center plane of the harvester. By a slightly slanted positioning of the pivot axes, the lateral parts are pivoted or swivelled such that projecting components of the harvesting device parts do not collide with other components upon pivoting and engage available free space in the final transport position. This means that, in a view from above onto the harvesting device that is in a transport position, the longitudinal center lines of the pivoted harvesting device parts are not parallel to the longitudinal center line of the central part of the harvesting device that extends transversely to the traveling direction.

A harvesting device that has been moved into the transport position in this way has a size that is so compact that the field of view of the driver of the harvester is not limited by the harvesting device. This is not only beneficial in regard to the field of view and traveling comfort but also improves traffic safety.

A further great advantage of the present invention, in particular for improving the traffic safety, resides in the compact dimensions and in the low weight of the harvesting device. These features improve the driving behavior because of the low center of gravity and a short distance to the front axle of the harvester in particular when driving fast on roads.

In further embodiments, a harvesting device having more than three parts is also conceivable; upon pivoting into the transport position; a package with four or more layers of harvesting device parts is provided by employing the features according to the invention.

With the configuration of the harvesting device in accordance with the present invention and in particular by means of the inventive arrangement of the pivot axes of the lateral parts, it is possible to operate the harvester with different working widths without having to change the harvesting device by pivoting one or both lateral parts of the harvesting device into a vertical inoperative position. By means of these different operating positions, the harvester operator is provided with entirely new working possibilities. For example, it is possible to employ only the center part of the harvesting device to harvest an area at the boundary of a field; subsequently, this harvested area can be used to completely unfold the harvesting device on the field without losing any of the crop. In particular in the case of harvesting devices with great working width, a complete unfolding outside of the field is often not possible; for this reason, loss of crop by driving into the field and unfolding within the crop to be harvested had to be accepted in the past.

In an especially advantageous embodiment of the harvesting device of a harvester according to the invention, the working width of the center part of the harvesting device, when the lateral parts are in their inoperative position, is matched in such a way to a standard row spacing of the crop such that safe harvesting of a number of rows is ensured so that additional rows of crop to be harvested are neither damaged nor flattened by driving across by parts of the harvesting device or by the harvester itself.

Accordingly, by means of the especially advantageous features of the invention a harvester is provided that comprises a very flexibly employable harvesting device with an enlarged working width that, when in the transport position, does not obstruct the field of view of the driver and increases traffic safety for driving the harvester on roads.

### BRIEF DESCRIPTION OF THE DRAWING

FIG. 1 is a perspective illustration showing a self-propelled agricultural harvester according to the invention in a working and operating position having a harvesting device subdivided into three parts for harvesting corn or a similar stalky crop.

FIG. 2 is a perspective illustration of the harvester according to FIG. 1 showing the lateral parts of the harvesting device transferred into the transport position.

FIG. 3 is a detail illustration of the area X of FIG. 1.

### DESCRIPTION OF THE PREFERRED EMBODIMENTS

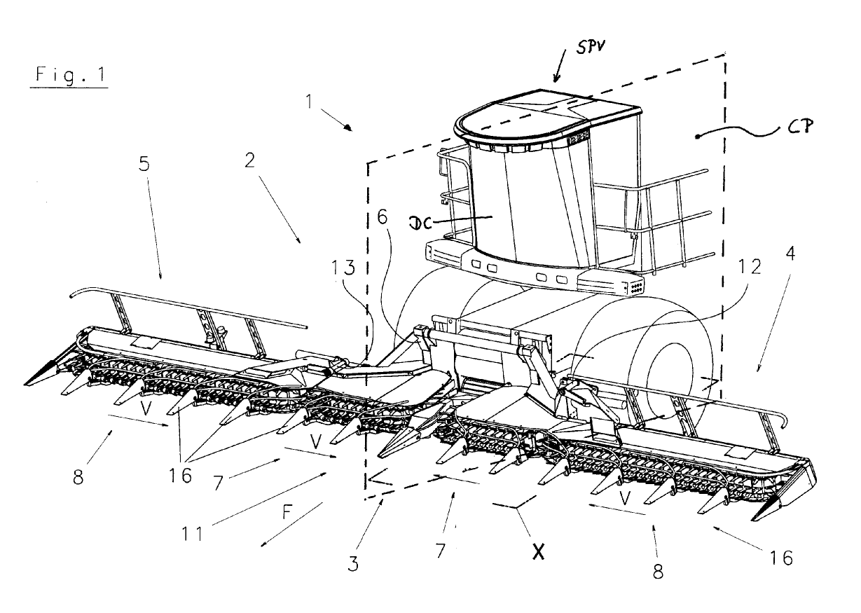

An embodiment of a self-propelled agricultural harvester 1 in the form of a field chopper with a harvesting device 2 that is used particularly as a front end attachment for row-independent harvesting of stalky crop such as corn or the like is illustrated in detail in FIG. 1. The harvesting device 2 is mounted preferably to the front end of a self-propelled working vehicle SPV (of which only two front wheels and the driver's cab DC are schematically shown) and is comprised preferably, as illustrated, of three parts 3, 4, 5. The central part 3 is connected by means of a base frame 6 fixedly to the harvester. The lateral parts (swivel parts) 4, 5 are pivotably connected to the outward edges of the central part 3 by a pivot axle 12, 13, respectively, defining a pivot axis. In the working position of the harvesting device 2 illustrated in FIG. 1, the lateral parts (swivel parts) 4, 5 are supported on the central part 3 in a way not described in detail and, if needed, are locked thereat.

The central part 3 as well as the lateral parts 4, 5 each comprise a mowing and conveying device 7 or 8 that is driven so as to circulate; the mowing and conveying device 7 or 8 cuts the crop with outwardly oriented cutting and holding elements 9, 10, picks up the crop, and conveys the crop.

The drive action of the mowing and conveying devices 7, 8 is realized by drive trains (not illustrated) connected to a power source of the harvester 1. When pivoting the lateral parts 4, 5 into an inoperative position, the drive trains of the lateral parts 4, 5 are disengaged (separated) and, in reverse, when pivoting the lateral parts 4, 5 into the working and operating position, are automatically connected (engaged).

In the illustrated embodiment, the harvesting device 2 is attached precisely centrally relative to the harvester 1 so that it extends symmetrically relative to a vertical longitudinal center plane CP of the harvester 1 on both sides. In order to be able to feed the crop supplied by the lateral parts 4, 5 simultaneously and uniformly to the intake area 11 of the harvester 1, the central part 3 of the harvesting device 2 is provided with two mowing and conveying devices 7 that are driven in circulation in opposite directions (arrows V) for feeding the crop into the harvester 1.

The lateral parts 4, 5 of the harvesting device 2 of the harvester 1 according to the invention in the shown embodiment are advantageously configured with only one mowing and conveying device 8, respectively, that is driven in circulation in the direction of arrow V and, during the working travel of the harvester, cuts, picks up, and conveys the entire crop within its reach exclusively at the front end facing in the travel direction F. The advantages of a configuration of the lateral parts 4, 5 with only one mowing and conveying device 8 are particularly the minimal weight, the very compact size, and thus also the favorable location of the center of gravity, and the drive-technologically simple configuration. In particular in the case of continuously increasing working widths of the harvesters, these are important criteria that affect the manufacturing costs, the handling, and the transport possibilities of the harvester in a decisive way.

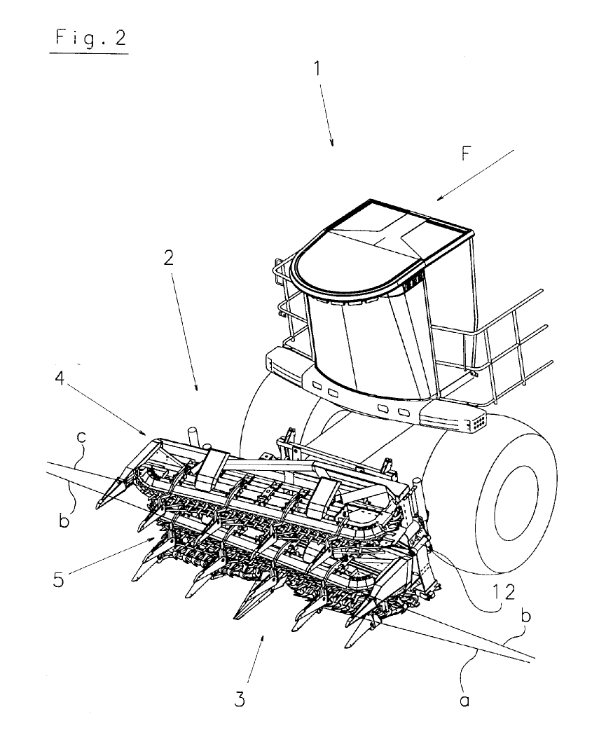

The very short configuration of a harvesting device 2 in the illustrated embodiment has advantages already in the working position illustrated in FIG. 1 with regard to short conveying travel of the crop to the intake area 11 of the harvester 1 and beneficial axle load distribution of the harvester. The transport position of the harvester illustrated in FIG. 2 however illustrates additional very advantageous features.

From the working position of the harvesting device 2 according to FIG. 1, in which working position all parts 3, 4, 5 with their correlated mowing and conveying devices 7, 8, respectively, are positioned in a plane that is at least approximately common to all parts and parallel to the ground, the transport position of the harvesting device 2 according to FIG. 2 is reached by pivoting the lateral parts 4, 5 about the pivot axles 12, 13 by means of hydraulic working cylinders (not disclosed in detail).

In this connection, the pivot axles 12, 13 that, relative to the vertical longitudinal center plane CP of the harvester 1, are positioned at different acute angles and additionally at different levels, enable because of their special different orientation a very compact optimized transport position of the parts 3, 4, 5 of the harvesting device 2 relative to one another. For moving the lateral parts 4, 5 into the transport position according to FIG. 2, first the lateral part 5 is pivoted about the lower pivot axle 13 by 180 degrees so that it is placed onto the center part 3 with its bottom side facing upwardly. In this connection, the slanted orientation of the pivot axle has the effect that the lateral part 5 can be stowed on the center part 3 spaced as closely as possible thereto without colliding with other components of the harvesting device 2 during the course of movement. Subsequently, the second lateral part 4 is also pivoted about 180 degrees but about the pivot axle 12 that is positioned at a significantly higher location but, for the same reasons as mentioned above, is also slantedly arranged. The higher position of the pivot axle 12 has the effect that in the transport position the lateral part 4 is stowed on the already pivoted lateral part 5 with its bottom side facing upwardly. The slightly displaced orientation of the parts 3, 4, 5 of the harvesting device 2 relative to one another in the transport position that is advantageous because of the already mentioned reasons is illustrated in FIG. 2 by the lines a, b, c that are indicated as extensions of the front ends of the parts 3, 4, 5 of the harvesting device 2 only for illustration purposes.

The advantageous transport position of the harvesting device 2 of the harvester according to the invention is illustrated particularly well in the illustration of FIG. 2. The harvesting device 2 with a working width of almost three times the width of the harvester provides in its transport position such a compact unit that, when remaining at the front end of the harvester 1 when driving on roads, it does not affect negatively the driving behavior because of its low weight and because of its center of gravity that is beneficially low and close to the harvester; moreover, the field of view of the driver is not obstructed. All this leads to a significant improvement of traffic safety.

Should such a harvesting device 2 of the illustrated embodiment be too wide in the transport position in its transverse direction for driving on roads, for example, as a result of its even further increased working width, and must therefore be transported on a separate transport vehicle, the embodiment according to the invention also has great advantages in this scenario because of its compact dimensions (size) and low center of gravity.

Because of the advantageous configuration of the harvesting device 2, the harvester 1 according to the invention can be operated in other advantageous working modes than those illustrated in FIG. 1 and FIG. 2.

For example, it is possible to pivot one or both lateral parts 4, 5 of the harvesting device 2 by only approximately 90 degrees into a position approximately perpendicular to the ground in order to harvest either with the smallest working width, i.e., only with the central part 3, or with a medium working width, i.e., with the central part 3 and one of the lateral parts 4, 5. Since the drive trains of the lateral parts 4, 5 are separated (disengaged) upon pivoting, the mowing and conveying devices 8 in the afore described additional inoperative position are shut down. These additional working modes can be, inter alia, very advantageous when there is insufficient space available outside of the field to be harvested in order to unfold the harvesting device completely into its working position according to FIG. 1. In such a case, a corresponding area of the field can be harvested with a reduced working width without causing any loss by driving across the crop or snapping off the crop.

The advantageous features of the harvesting device 2 of the illustrated embodiment of the harvester 1 according to the invention described above are based almost exclusively on the basic principle of the mowing and conveying devices 7, 8 and their configuration and use in accordance with the present invention.

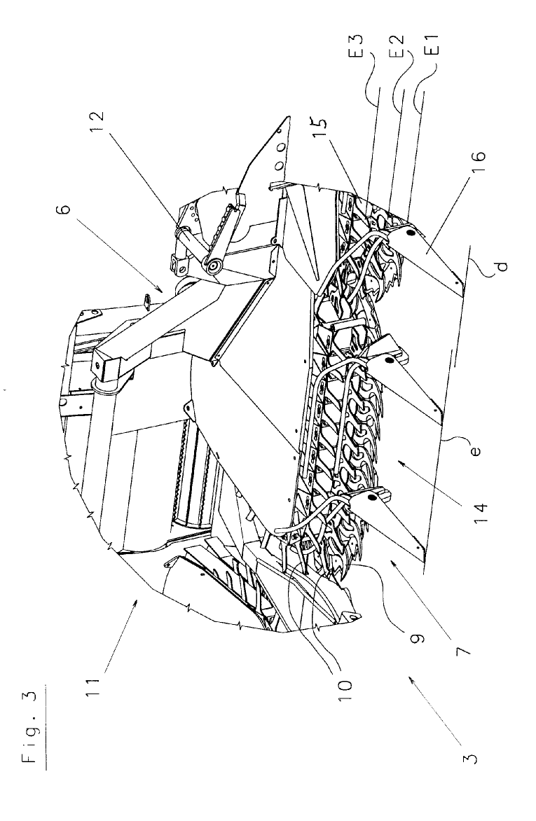

The mowing and conveying devices 7, 8 comprise primarily, as can be seen in particular in the detail view of FIG. 3, pivotably connected segments 14 and cutting and holding elements 9, 10 arranged thereat. The cutting and holding elements 9, 10 point outwardly and are positioned in stacked planes E1, E2, E3. Each segment 14 has in the lower plane E1 a cutting element 9, in the central plane E2 a holding element 10, and in the upper plane E3 a further holding element 10, respectively. The pivotably connected segments 14 of the mowing and conveying devices 7, 8 are driven in circulation by at least two driving and deflecting wheels (not illustrated) such that they cut, pick up, and convey like an endless conveyor, linearly in the direction of arrow V, the crop to the center of the harvesting device 2 with the run that is positioned in front in the traveling and working direction F. A critical point of the conveying action is the interruption-free and loss-free transfer of the crop at the interface between the central part 3 and the lateral parts 4, 5. In these areas, the entire crop that has been picked up and conveyed by the mowing and conveying device 8 up to this point must be transferred to the inwardly positioned mowing and conveying device 7 of the harvesting device, respectively, and must be picked up by it while simultaneously additional crop must be cut and picked up.

This transfer is enabled primarily by a special arrangement of the neighboring mowing and conveying devices 7, 8 of each half of the harvesting device, respectively. The spacing of the lines d and e in FIG. 3, representing parallel lines relative to the harvesting device parts 3, 4, illustrate clearly the displaced arrangement of the lateral parts 4, 5 relative to the central part 3. By means of the positioning of the parts 3, 4, 5 of the harvesting device 2 at the same forward slant in such a way that the lower cutting plane E1 of the mowing and conveying devices 7, 8 are spaced at the same spacing to the ground so that the crop is cut across the entire working width at the same level, overlap of the circulating plans E1, E2, E3 of the cutting and holding elements 9,10 is enabled without causing collision.

These features and the advantageous use of segments 14 as small as possible, enabling thus deflection of the mowing and conveying devices 7, 8 at small radii particularly at the transfer areas, result in fast opening and closing of the receiving spaces 15 between the holding elements 10 of the mowing and conveying device; for simultaneous overlap of the circulating planes and identical direction of rotation this results in a disruption-free transfer of the crop.

In order to assist the transfer action and to optimize guiding of the crop across all areas, the mowing and conveying devices 7, 8 have stalk dividers 16 with guide brackets arranged thereat.

As a result of the combination of the described features of the illustrated embodiment, crop transport exclusively at the front side of the harvesting device is possible, even across interfaces of the harvesting device 2 with required transfer from one mowing and conveying device 8 of one lateral part 4, 5 to a mowing and conveying device 7 of the central part 3 while simultaneously additional crop is harvested and picked up. Further embodiments with, for example, more than one foldable lateral part for each half of the harvesting device are also conceivable.

While specific embodiments of the invention have been shown and described in detail to illustrate the inventive principles, it will be understood that the invention may be embodied otherwise without departing from such principles.

What is claimed is:

1. A harvester comprising:
a self-propelled vehicle;
a harvesting device arranged in a traveling and working direction of the harvester in front of a driver's cab;
the harvesting device comprising at least a first part, a second part, and a third part;
the harvesting device extending with a device length thereof in a direction transverse to the traveling and working direction;
wherein at least the first and second parts are swivel parts that are pivotable about approximately 180 degrees about a pivot axis, respectively, which pivot axis extends at least approximately in the traveling and working direction, such that the swivel parts are transferable from a working position in which the swivel parts extend transversely to the traveling and working direction into a transport position, wherein in the transport position legally permissible dimensions for traveling on roads are observed;
wherein a longitudinal extension of the swivel parts transverse to the traveling and working direction matches at least approximately a maximum legally permissible transport width.

2. The harvester according to claim 1, wherein the harvesting device is a mowing and conveying device or a pick-up device.

3. The harvester according to claim 1, wherein the harvesting device is a three-part device comprised of the first, second and third parts, wherein the third part comprises a base frame that is transversely arranged to the traveling and working direction and is centrally arranged relative to a vertical center plane of the harvester, wherein the first and second parts are pivotably connected to opposed ends of the third part.

4. The harvester according to claim 1, wherein the harvesting device has a first operating position in which the at least first, second and third parts extend transversely to the traveling and working direction and transversely to a vertical center plane of the harvester, wherein the harvesting device has additional operating positions by pivoting at least one of the swivel parts into an inoperative position in which the at least one of the swivel parts is approximately parallel to the vertical center plane.

5. The harvester according to claim 1, wherein the at least first, second and third parts each have a mowing and conveying device and the mowing and conveying devices convey as an endless conveyor a harvested crop to an intake area of the harvester.

6. The harvester according to claim 1, wherein the third part comprises a base frame, transversely arranged to the traveling and working direction and centrally arranged relative to a vertical center plane of the harvester, and further comprises at least two mowing and conveying devices that convey a harvested crop first transversely to the traveling and working direction inwardly and subsequently rearwardly in a direction counter to the traveling and working direction to an intake area of the harvester.

7. The harvester according to claim 1, wherein the harvesting device is a front attachment and is located in the transport position of the first and second parts outside a viewing area of a driver of the harvester.

8. The harvester according to claim 1, wherein the at least first, second and third parts in the transport position are horizontally aligned relative to one another and to the ground, wherein the at least first, second and third parts are at least approximately parallel.

9. The harvester according to claim 1, wherein at least two of the pivot axes are positioned in a horizontal plane, respectively, wherein the horizontal planes are spaced apart.

10. The harvester according to claim 1, wherein the pivot axes are positioned at an angle relative to a vertical center plane of the harvester that extends in the traveling and working direction of the harvester such that center lines of the swivel parts in the transport position in a top view toward the ground define an acute angle to a longitudinal center line of the third part that is not pivoted.

11. The harvester according to claim 1, wherein the harvesting device is a three-part device that has a working width matching at least approximately a value of three times the maximum legally permissible transport width.

12. The harvester according to claim 1, wherein the harvesting device is a front attachment for row-independent harvesting of corn.
